(19) United States
(12) Patent Application Publication
(10) Pub. No.: US 2024/0246720 A1
(43) Pub. Date: Jul. 25, 2024

(54) STORAGE CONTAINER

(71) Applicant: ICEE HOLDINGS PTY LTD, Tullamarine, Victoria (AU)

(72) Inventors: Hamish HINGSTON, North Melbourne (AU); Sergio DE ALMEIDA, Mill Park (AU); Derek JEFFERSON, Hillside (AU); Manivannan BALASUBRAMANIAM, Kensington (AU)

(73) Assignee: ICEE HOLDINGS PTY LTD, Tullamarine, Victoria (AU)

(21) Appl. No.: 18/563,202

(22) PCT Filed: May 23, 2022
(86) PCT No.: PCT/AU2022/050491

§ 371 Date: Nov. 21, 2023

(30) Foreign Application Priority Data
May 21, 2021 (AU) 2021901522

(51) Int. Cl. B65D 6/18; B65D 43/16; B65D 81/38

(52) U.S. Cl. CPC B65D 11/1833; B65D 43/166; B65D 81/3816; B65D 2543/00194; B65D 2543/00296

(57) ABSTRACT

A container for storing items in an insulated environment, comprising: a base having integrally formed opposing end supports projecting above a surface of the base and at least one elevated edge extending between the opposing end supports; a pair of end walls, each end wall hingedly mounted to an upper end of the end supports; a pair of side walls, one of the side walls being hingedly mounted to a surface of the base along an edge thereof to extend between the end supports and the other side wall being hingedly mounted to an upper end of the elevated edge of the base to extend between the end supports; and a pair of lid members, each lid member being hingedly mounted to an upper end of the end walls or side walls; wherein, in a first folded state each of the side walls, end walls and lid members are foldable to extend over the base in a stacked manner, and in a second assembled state each of the side walls, end walls and lid members are interengage to form a sealed and insulated storage space.

### RELATED APPLICATION

The present application claims priority from Australian provisional patent application no. 2021901522, filed 21 May 2021, the entire contents of which are incorporated herein by reference.

### FIELD OF INVENTION

The present invention relates generally to a storage container, and in particular, to a thermally insulated container having foldable walls configured to enable the container to be efficiently stored when not in use.

### BACKGROUND OF THE INVENTION

Thermally insulated storage containers are generally used to provide a means for containing items in a controlled thermal environment for storage or transport. Such containers have a variety of different applications ranging from receiving foods, as well as medicines and the like, and for maintaining them in a controlled thermal environment to maximise their usable life. The controlled thermal environment could be a heated environment or a chilled environment, depending upon the item being stored in the container.

Conventional thermal insulated containers have generally been formed from a polymeric foam material, such as expanded polystyrene (EPS) or expanded polypropylene (EPP). Such materials have known thermal insulation properties and can be moulded in an efficient and cost effective manner to form a single three-dimensional container in a single piece. Such containers can then be used to store items, such as foodstuff, in a chilled or heated state, and lids can be fitted to the openings thereof to form an enclosed space within which the thermal environment can be retained for extended periods of time.

However, conventional single piece moulded containers have a number of disadvantages. One significant disadvantage is that they take up substantially the same volumetric space irrespective of whether they contain items or not. As such, when the containers are not in use, they require considerable storage space. This can be a considerable problem when the containers are used for transporting goods, as the containers require considerable storage space, even when empty. This can result in the containers being destroyed or disposed of, significantly minimising their usage life.

A number of attempts have been made to provide collapsible containers that, when not in use, can be collapsed to significantly minimise the storage space required to store the containers. However, such attempts have largely relied upon ease of collapsing the container, thereby requiring gaps or spaces between walls of the container to facilitate folding of the walls. This has resulted in containers that are able to be collapsed when not in use, but which have a significantly compromised thermal insulation capacity when compared to conventional one piece, three-dimensional containers.

Thus, there is a need to provide a container that is configured to be reduced in volume for storage, but which maintains high insulation properties when in use.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a container for storing items in an insulated environment, comprising:
a base having integrally formed opposing end supports projecting above a surface of the base and at least one elevated edge extending between the opposing end supports;
a pair of end walls, each end wall hingedly mounted to an upper end of the end supports;
a pair of side walls, one of the side walls being hingedly mounted to a surface of the base along an edge thereof to extend between the end supports and the other side wall being hingedly mounted to an upper end of the elevated edge of the base to extend between the end supports; and
a pair of lid members, each lid member being hingedly mounted to an upper end of the end walls or side walls;
wherein, in a first folded state each of the side walls, end walls and lid members are foldable to extend over the base in a stacked manner, and in a second assembled state each of the side walls, end walls and lid members are interengage to form a sealed and insulated storage space.

In one embodiment, the upper end of the elevated edge of the base is elevated above the surface of the base a height equivalent to a thickness of the side wall mounted to the surface of the base. In this embodiment, when the side walls are folded inwardly in the first folded state, the side wall mounted to the surface of the base is positioned below the side wall mounted to the elevated edge of the base. When the side walls are folded inwardly in the first folded state the combined height of the side walls above the surface of the base may be substantially the same as the height of the end supports above the surface of the base. When the end walls are folded inwardly in the first folded state, the end walls are supported on an upper surface of the folded side walls.

The pair of side walls may be mounted to the surface of the base and the upper end of the elevated edge of the base by way of one or more hinge members. The hinge members may be configured to facilitate pivotal movement of the side walls between the first folded state and the second assembled state and to prevent pivotal movement of the side walls outside of these states.

The pair of end walls may be mounted to the upper end of the end supports by way of one or more hinge members. The hinge members may be configured to facilitate pivotal movement of the end walls between the first folded state and the second assembled state and to prevent pivotal movement of the end walls outside of these states.

Each of the end walls may have side members that project from opposing sides of the end walls to engage with the side walls when the end walls and side walls are in the second assembled state. The side members may project in a direction toward the other end wall when the end walls are in the second assembled state. The side members of the end walls may engage with the side walls to form a sealed edge therebetween. A groove may be formed along an inner surface of the side members that receives a tongue member formed on an outer surface of the sidewall, or vice versa, to form the sealed edge therebetween.

An interface between the base and the side walls and the base and the end walls may be configured to form a seal therebetween when the side walls and the end walls are in the second assembled state.

The seal may be formed by a rib provided in either the end wall/side wall or base being received in a channel provided in either the base or end wall/side wall when the side walls and end walls are in the second assembled state. The rib may be configured to be slightly larger than the channel such that when the rib is brought into contact with the channel an interference fit is created to form a seal along the interface.

In one embodiment, the base, side walls, end walls and lid members are detachable.

### BRIEF DESCRIPTION OF THE DRAWINGS

The invention may be better understood from the following non-limiting description of preferred embodiments, in which:

FIG. 1 is a perspective view of a container in accordance with an embodiment of the present invention;

FIG. 2 is a view of a perspective view of the container of FIG. 1 in a collapsed state for storage; and

FIG. 3A and FIG. 3B are bottom perspective views showing the container of the present invention in a collapsed and assembled state respectively;

FIG. 4 is a cross-sectional view of the container of the present invention in a folded or collapsed state;

FIG. 5 is a perspective view of the container of the present invention in a partially folded or collapsed state;

FIG. 6 is a perspective view of the container of the present invention in a disassembled state;

FIG. 7 is a perspective view of the container of the present invention with a lid member removed;

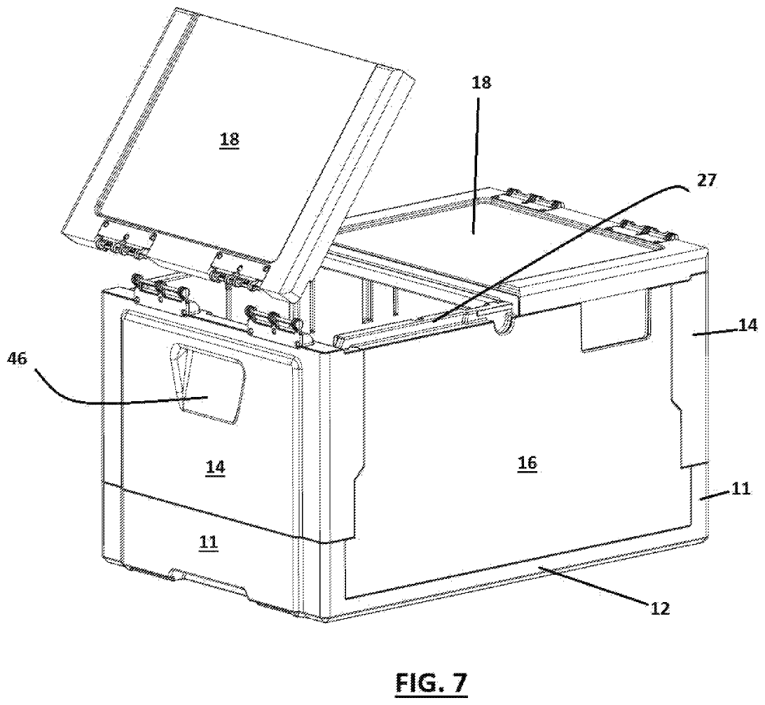

FIG. 8 is an enlarged view of a hinge element of the present invention;

FIG. 9 is a perspective view of the container of the present invention with the lid members partially open;

FIG. 10 is a perspective view of the container of the present invention with the lid members in an open position;

FIG. 11 is a perspective view of a thermal pack for use with the container of the present invention;

FIG. 12 is a partially cut-away view of the container of the present invention employing the thermal packs of FIG. 11;

FIG. 13 is a top perspective view of the container of the present invention using the thermal packs of FIG. 11;

FIG. 14 is an enlarged view of a hinge element in accordance with an embodiment of the present invention;

FIG. 15 is an enlarged view of a sealing arrangement for the container in accordance with an embodiment of the present invention;

FIG. 16 is a perspective view of the container of the present invention depicting a bag holding system in accordance with an embodiment of the present invention; and

FIG. 17 is a perspective view of the container of the present invention depicting a locking mechanism for locking the lid members in position in accordance with an embodiment.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The container of the present invention will be described below in relation to its formation from expanded polypropylene (EPP). However, it will be appreciated that the container of the present invention could be formed from any variety of materials, including other polymeric foam materials such as expanded polystyrene (EPS) or polyurethane, or any other plastic material capable of providing a thermal. insulation.

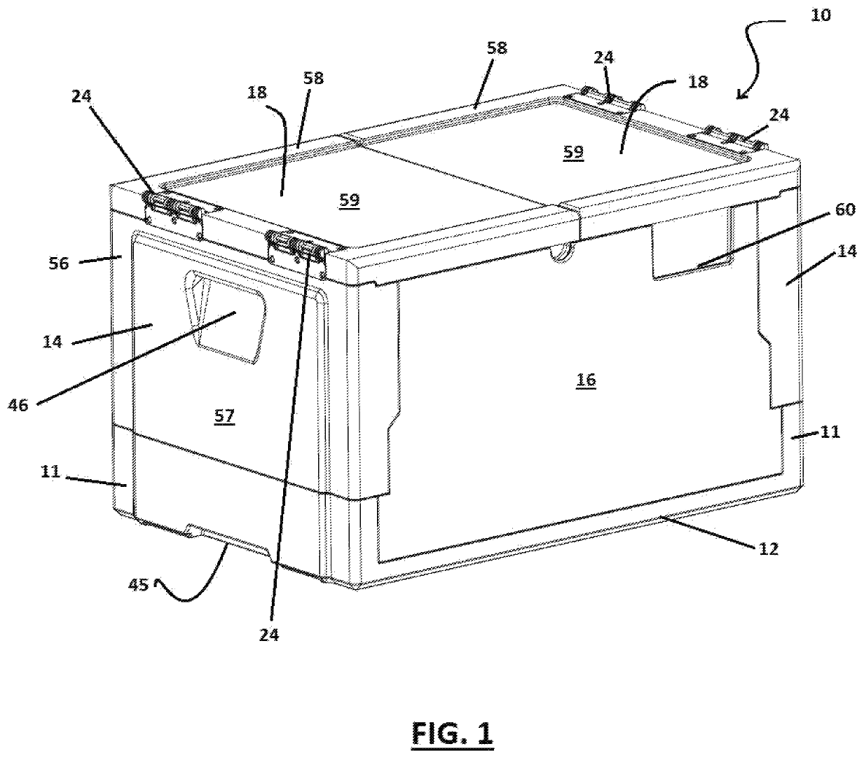

Referring to FIG. 1, a container 10 in accordance with an embodiment of the present invention is shown in an assembled form. The container 10 generally comprises a base 12, a pair of opposing end walls 14 and a pair of opposing side walls 16. In the embodiment as shown, lid members 18 are attached to an upper end of the end walls 14; however, in an alternative embodiment, the lid members may be attached to the upper end of the side walls 16.

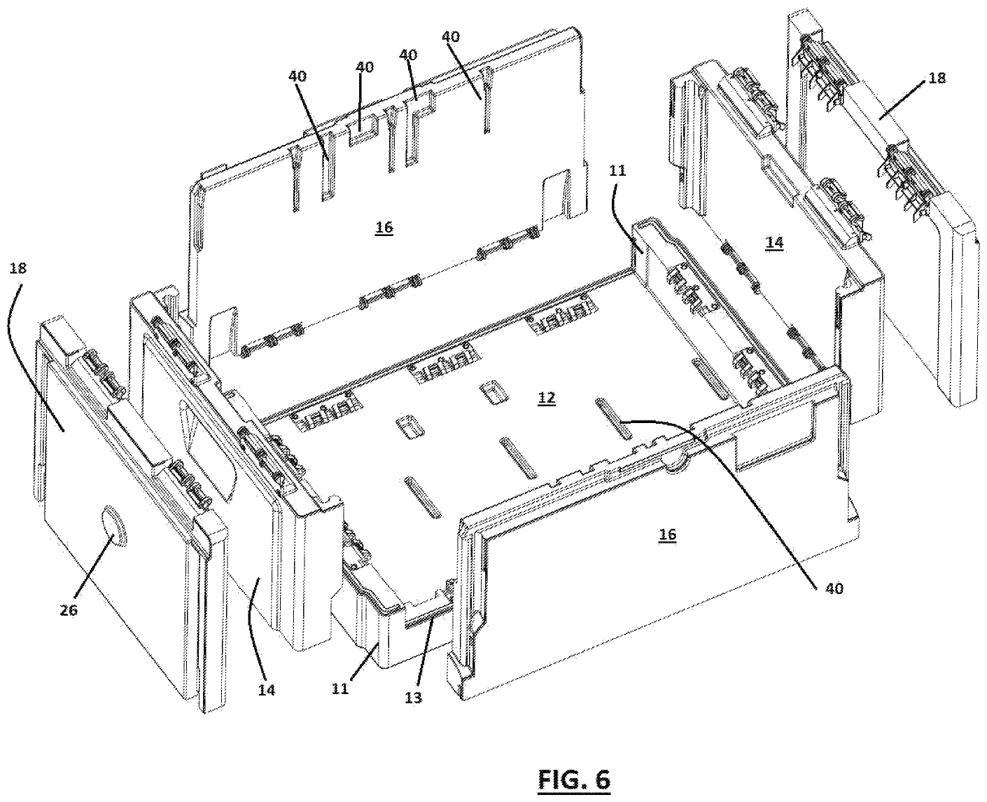

The base 12 is configured to comprise a pair of opposing end supports 11 that project from the base 12 in an upward manner. The end supports 11 extend across a width of the base 12 and are formed integral with the base 12. The end supports 11 support the end walls 14 thereon, as is shown in FIG. 1. The portion of the base 12 extending between the end supports 11 is a substantially planar surface that forms the bottom surface of the container 10 when the container is in the assembled form as shown in FIG. 1. As is shown more clearly in FIG. 6, a step 13 having a top surface that is elevated above the upper surface of the base 12 is provided along one side edge of the base 12 to support a side wall 16 in a manner to be described in more detail below.

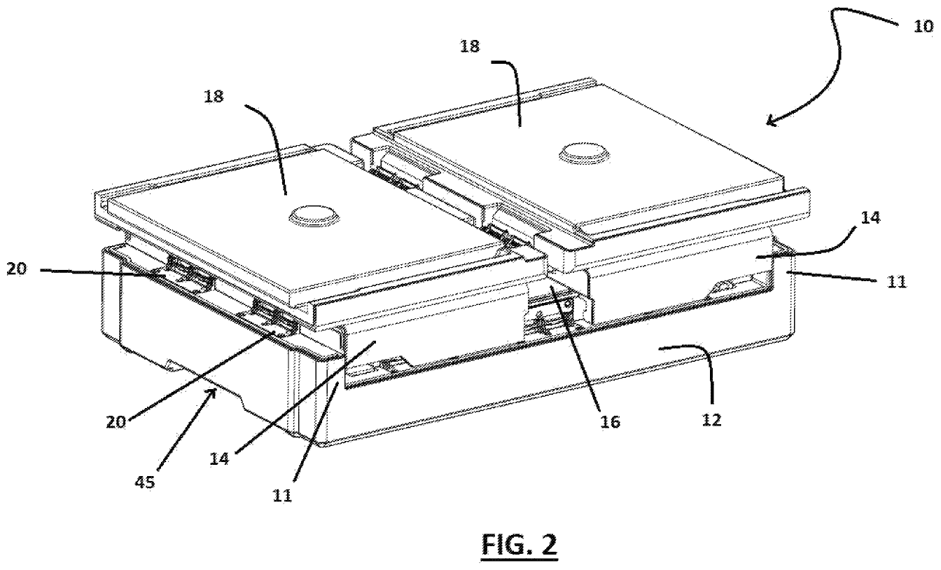

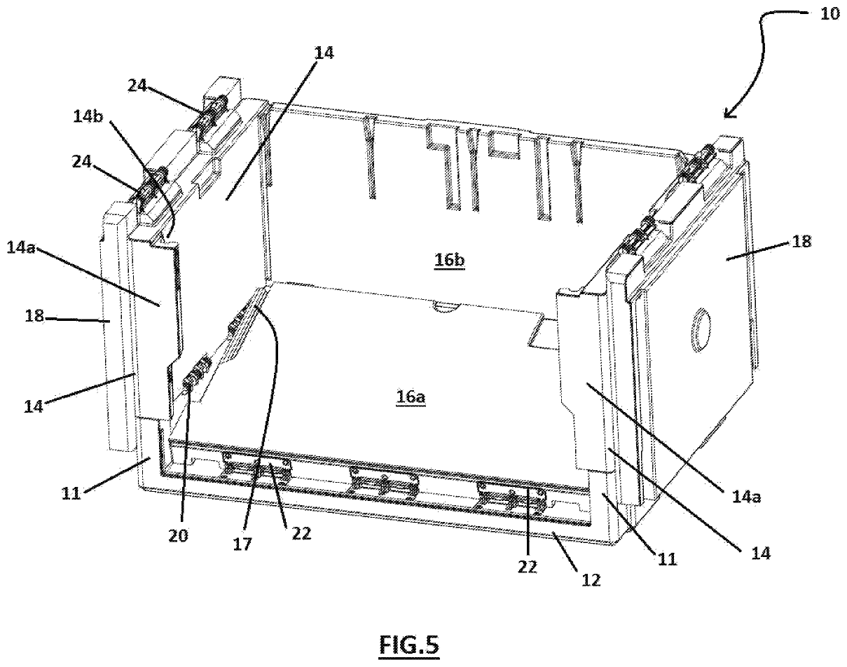

As is shown more clearly in FIG. 5, the side walls 16a, 16b are each positioned to extend along an opposing side edge of the base 12. To facilitate folding of the container 10 into the configuration as shown in FIG. 2, one side wall 16a is mounted to the surface of the base 12 by way of hinges 22. The other side wall 16b is mounted to the upper surface of the step 13 also by way of hinges 22.

In the case of side wall 16a, the hinges 22 mount a bottom edge of the side wall 16a to the surface of the base 12. A connecting knuckle of the hinge 22 is mounted to an underside of the side wall 16a and is orientated such that the connecting knuckle attaches to a respective hinge plate located internally with respect to the container. As is shown in FIG. 6, the hinge plate is connected to the base 12 inside the edge of the base 12 and is recessed below the surface of the base 12. This ensures that when the side wall 16a is folded inwardly, it sits flush with the surface of the base 12.

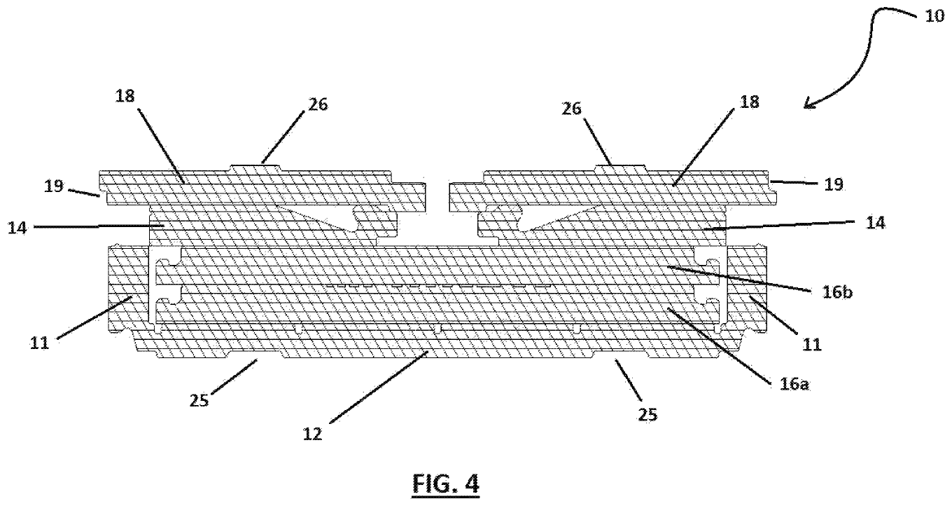

In the case of side wall 16b, side wall 16b is mounted to an upper surface of the step 13 by way of hinges 22 in the similar manner to side wall 16a. The step 13 has a height sufficient to the width of the side wall 16a, such that when the side wall 16b is folded inwardly it will sit flush upon the surface of the folded side wall 16a, as is shown more clearly in the cross sectional view of FIG. 4. Thus, the hinges 22 of one side wall 16 are arranged in a plane that is vertically displaced from the hinges of the other side wall 16. In such a hinged configuration, due to the arrangement of the hinges, the side walls 16a, 16b are able to fold or pivot inwardly, in the manner as shown in FIG. 5, and are prevented from folding in an outward manner.

As is shown in FIG. 4, when the side walls 16a, 16b are folded inwardly in the manner as described above, the height of the combined thickness of the side walls 16a, 16b is substantially the same as, or slightly less than, the height of the end supports 11. This provides for compact folding of the container 10 and minimal gaps between the folded components, as will be described further below.

Referring to FIG. 2, the end walls 14 are mounted to the end supports 11 by way of hinges 20. The hinges 20 provide a pivotal connection between a bottom edge of the end walls 14 and a top edge of the end supports 11. This orientation of the hinges 20 enables the end walls 14 to fold inwardly with respect to the container 10 in the same manner as side walls 16, and prevents the end walls 14 from being folded outwardly. As can be more readily seen in FIG. 5, the knuckle of the hinges 20 that connects the end walls 14 to the end supports 11 is orientated such that is located on the inside of the container 10 to facilitate such inward pivotal movement of the end walls into the folded configuration as shown in FIG. 4.

It will be appreciated that due to the end supports 11 being substantially the same height as the combined thicknesses of the side walls 16a, 16b, the end walls 14 will sit flush upon the surface of the side wall 16b when the container 10 is in the collapsed configuration as depicted in FIG. 2 and FIG. 4. Further, as the combined height of the end walls 14 is less than the distance between the end supports 11, the end walls 14 can be folded to extend along the same plane and will not overlap.

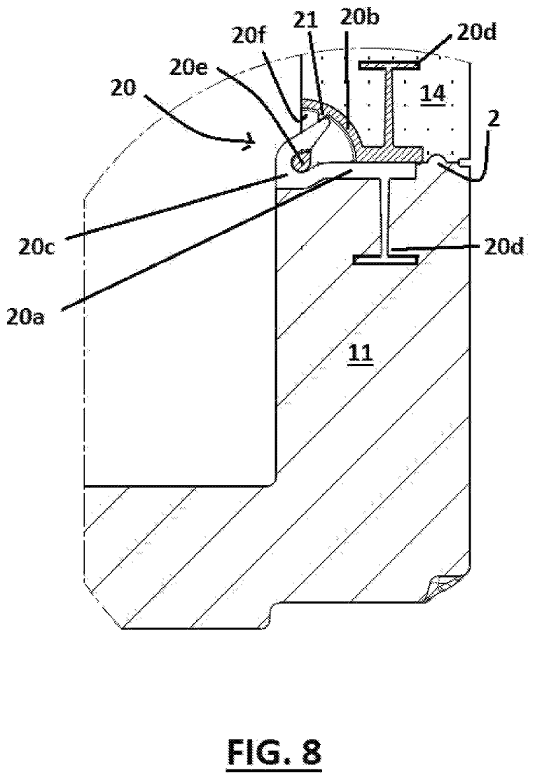

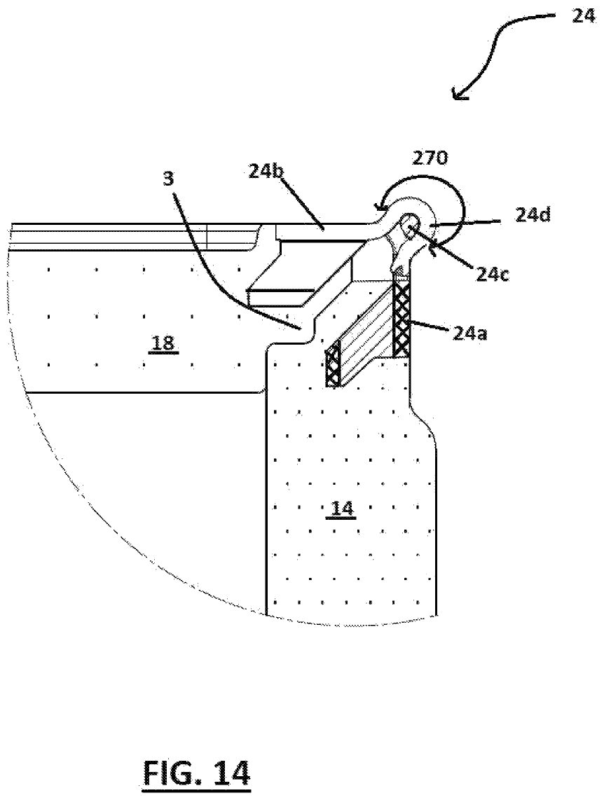

Referring to FIG. 14, the manner in which the lid members 18 are attached to the end walls 14 is shown. The upper edge of the end walls 14 have mounting projections formed thereon to which hinge plate 24a is attached. Hinge plate 24a comprises a pin member 24c having a cam profile that projects vertically above the upper end of the end wall 14, as shown. The end of the lid member 18 has a hinge plate 24b mounted to an upper end thereof. The hinge plate 24b has a knuckle 24d that projects from the end of the lid member 18 to receive the pin member 24c of the hinge plate 24a. In this arrangement, the hinge 24 allows the lid member to move through an arc of approximately 270°. This enables the lid members 18 to move between a closed position as shown in FIG. 1 to an open position as shown in FIG. 5. As is shown in FIG. 14, as the container is formed from expanded material, the lid member 18 and the end walls 14 may be formed to have a stepped region 3 located in the interfacing surfaces. Such a stepped region 3 provides an interference fit between the two surfaces when they are in the closed position as shown in FIG. 8 thereby utilising the elastic properties of the expanded material to create a seal therebetween to further enhance the thermal insulation properties of the container 10 during use.

Due to the 270° movement of the lid members 18 with respect to the end walls 14, when the container 10 is in the folded or collapsed position as shown in FIG. 2 and FIG. 4, the lid members 18 are able to be folded in a backwards manner with respect to the end walls 14. This ensures that the lid members 18 sit flush upon the outer surfaces of the respective end walls 14, thereby providing a compact folded container with the folded components each being supported by an underlying component with each component extending substantially parallel to each other. In such an arrangement the collapsed containers can be stored in a stacked manner that is both compact and stable.

As discussed above, the components of the container 10 are all made of expandable material, such as EPP. The hinges 20, 22, 24 are made of a polymer compatible with the expanded material and the hinges 20, 22, 24 are bonded to the expandable material during the formation process by inserting the hinges 20, 22, 24 into the expanded material during the steam moulding cycle such that the hinges 20, 22, 24 molecularly bond with the expanded material. The bonding process also utilises an overmoulding process whereby the hinge components are provided with voids formed in the ribs such that as the material expands during the forming process, the expanding material will create an undercut and provide a mechanical interlocking function. Whilst molecular bonding between the hinges and the expanded material is preferable, it will be appreciated that other bonding techniques, such as gluing, screwing, press fitting and the like, could be employed as would be appreciated by those skilled in the art.

The number of hinges 20, 22, 24 employed may vary depending upon the size of the container 10. As discussed above, the hinges 20, 22, 24 are inserted into the expandable material to be specifically positioned to form adjacent junctions between the different components of the container. This provides a kinematic hinge between the components that allows the components of the container to collapse over and within the footprint of the base and, enables assembly and formation of the container by simply unfolding the components from the base.

The manner in which the hinge 20 is embedded within the structure of the container is depicted in FIG. 8. In this embodiment, the hinge 20 provides hinged connection between the end support 11 of the base 12 and the end wall 14. The hinge 20 comprises two parts or leafs 20a and 20b. The first leaf 20a is embedded into the upper end of the end support 11 such that it extends substantially flush with the upper end thereof, with one or more knuckles 20c extending above the surface of the end support 11 to be substantially flush with an inner edge thereof. To facilitate bonding contact between the leafs 20a, 20b and the material of the end supports 11 and end walls 14, fingers 20d are provided that extend into the material and provide a bonding surface for bonding with the expanded foam material during the moulding process. As mentioned above, voids (not shown) may be provided in the fingers 20d to provide overmoulding to further improve the bonding process.

Leaf 20b is embedded into the lower end of the end wall 14 such that it extends substantially flush with the lower end thereof. A pin member 20e having a cam profile extends below the lower end surface of the end wall 14 and beyond a front edge thereof as shown. The pin member 20e is received within the knuckles 20c of the corresponding leaf 20a to engage therewith complete the hinge 20. The pin member 20e is then able to rotate within the knuckle 20c to facilitate pivotal movement of the end wall 14 with respect to the end support 11, in the manner as described above. Due to the shape of the pin member 20e, namely the cam profile, the pin member 20e will have a tighter fit within the knuckle 20c as the end wall 14 is rotated into a vertical or erected position as shown in FIG. 8. This will provide a degree of final resistance within the hinge 20 as the end wall 14 is rotated into position to help securely retain the hinge 20 in the locked position.

The leaf member 20b, has an arc recess 20f within which the hook portion of the knuckle 20c is accommodated as the end wall 14 moves between the folded and erected positions. A rib member 21 is provided to project from an inner surface of the arc recess 20f. The rib member 21 contacts the end of the hook portion of the knuckle 20c, in the manner as depicted in FIG. 8, when the end wall 14 is in the vertical or erected position, as shown. The rib portion 21 functions to restrain the end of the hook portion of the knuckle 20c to avoid bending and rupture of the hinge 20 when there is a pressure exerted on the inner walls of the container, as may occur due to contents present within the container. Such an arrangement adds considerable strength to the hinge 20 during use.

As is shown in FIG. 8, to provide a sealed connection between the surface of the end wall 14 and the end support 11, a projection 2 may be formed in either of the contacting surfaces of the end wall 14 or end support 11. In this regard, when the two surfaces are brought into contact by rotating the end wall 14 into the erected or vertical position as shown, the projection 2 formed in the expanded foam material of the surface will be compressed to create a seal between the opposing surfaces. This creates an interference between the two surfaces to form a sealed interface between the end wall 14 and the end support 11 when the components are in the assembled position.

It will be appreciated that the arc recess 20f of the leaf member 20b also functions to increase the strength of the hinge 20 during formation. During formation of the expanded foam material, the arc recess 20f captures the expanded material and creates a barrier that blocks the material from invading areas that need to be free to facilitate pivotal movement of the hinges, without the need for dedicated mechanisms in the design of the tooling to achieve this.

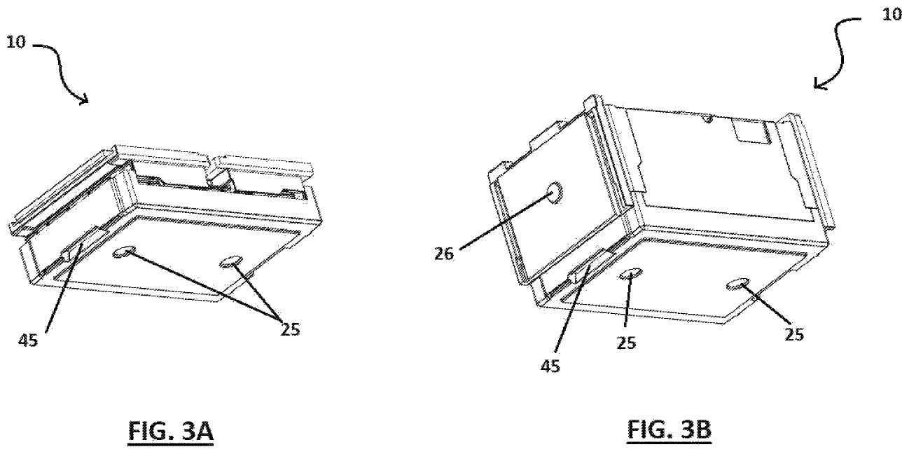

The manner in which the components of the container are formed makes it possible for the container to be converted to the collapsed form (FIG. 3A) by rotating and positioning the end walls and side walls with no interference between the hinges. Similarly, the collapsed container can be simply assembled into the assembled form (FIG. 3B) by unfolding the components to form an erected container that provides surface contact and sealing between the side walls and the end walls along each of the fold lines. This creates an assembled container that can contain a fluid without leaks occurring at the hinged areas and which provides for a sealed internal space having an improved thermal performance.

Referring to FIG. 5, a manner in which the container is configured to facilitate sealing of the walls to maximise insulation of the assembled container 10 is depicted. The sides of each of the end walls 14 have projecting members 14a that project forward in a direction toward the other end wall when the end walls 14 are in the vertical position as shown. The projecting members 14a are configured to engage with the side walls 16 when the side walls 16 are erected into the vertical position. This interaction between the projecting members 14a and the side walls 16 functions to hold the end walls 14 and the side walls 16 in the assembled position and provide a sealed edge therebetween, which extends about the internal storage space of the container.

A groove 14b is formed along an inner surface of the projecting members 14a that receives a tongue member 17 formed on an outer surface of the side wall 16 when the side wall 16 is raised into a vertical orientation. To further enhance engagement and the seal between the side wall 16 and the end wall 14, the distal edge of the projecting member 14a may be shaped to have a stepped configuration that substantially matches with the stepped configuration of the vertical edge of the side wall 16. Such an arrangement further ensures that there is no gap or clearance between the side walls 16 and the end walls 14 when erected into the container to maximise the thermal efficiency of the container 10.

Further to this, by providing such a male/female fitting between the end walls 14 and the side walls 16 when the container is in the assembled position, a union is formed between the longer and shorter sides of the container 10. Such a union provides interlock between the longer and shorter sides in such a way that should the container 10 be lifted by the handles 46, the load is dispersed throughout the container structure, rather than at the ends where the handles are located. In this regard, the load is supported/shared not only by the hinges 20 connecting the end walls 14 and the end supports 11 where the handles 46 are located, but also by the hinges 22 connecting the base 12 and the side walls 16.

To facilitate stacking of the collapsed containers 10 as depicted in FIG. 3A, the underside of the base 12 is provided with indentations 25. The indentations 25 are depicted in the form of a pair of circular indentations moulded into the undersurface of the base 12, however the number and shape of the indentations 25 may vary. As shown in FIG. 3B, the undersurface of the lid members 18 are provided with projections 26, in the form of circular projections having a diameter substantially the same as the circular indentations 25 formed in the undersurface of the base 12. Similarly, the number and shape of the projections 26 may vary. As discussed above and as is shown in relation to FIG. 4, when the container 10 is in the collapsed position for storage, the lid members 18 are folded back against the end walls 14 such that the projections 26 are exposed on a top surface of the collapsed container. In this configuration the projections 26 are located at the same position on the top surface of the collapsed container as the indentations 25 provided on the undersurface of the base 12. As a result when one collapsed container 10 is positioned atop another collapsed container the indentations 25 on the base 12 of the upper container receive the projections 26 on the upper surface of the lower container thereby providing a nested interference between the stacked containers to provide stability between containers in a stack. It will be appreciated that the shape, number and location of the projections/indentations could vary.

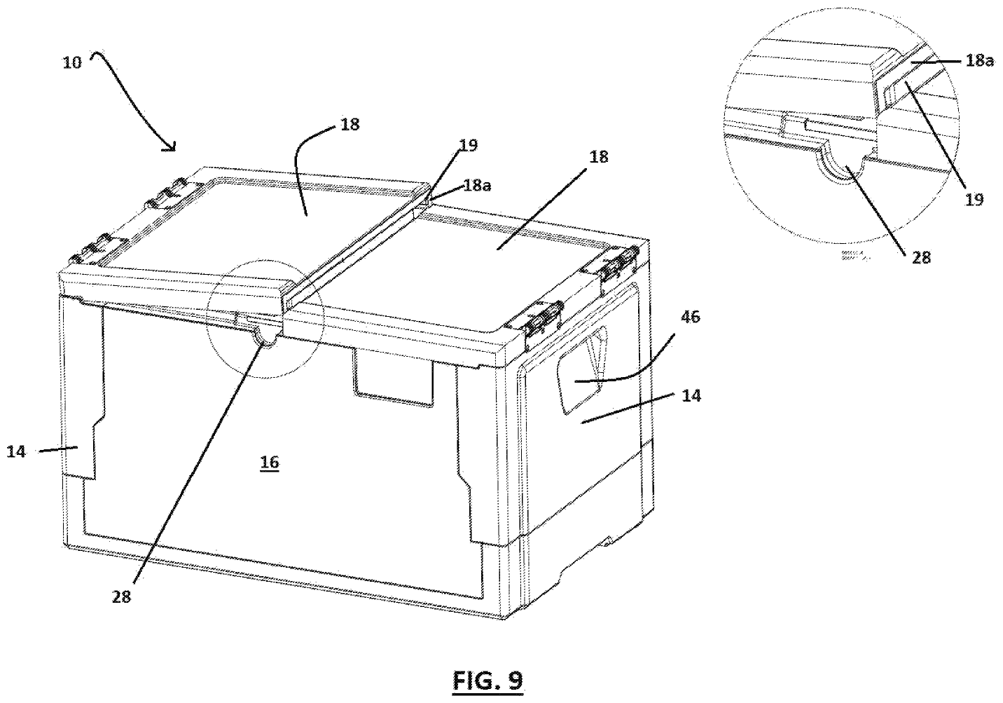

To enhance the thermal efficiency of the assembled container, the lid members 18 are configured such that when they are folded into the closed position of FIG. 1, they interlock along their connecting edge. This is depicted more clearly in FIG. 9. The free ends 18a of the lid members 18 are configured to have a complimentary step 19 formed therein such that when the lid members 18 are in the closed position they create a compression fit that seals the container along this common edge. The complimentary steps 19 are shown more clearly in FIG. 4.

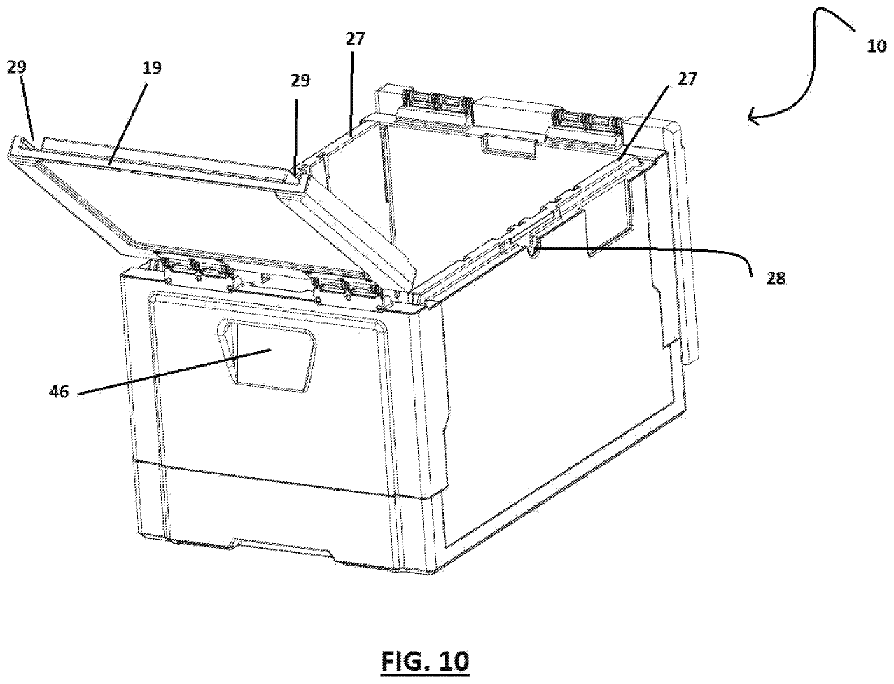

As shown in FIG. 9 and FIG. 10, as the compression fit between the free ends 18a of the lid members 18 creates an airtight seal, in order to open the container 10 a recess 28 is provided along the top edge of the side walls 16 to enable a user to lift and separate the lid members 18 to access the internal space of the container 10.

Not only do the lid members 18 form a seal at their free ends 18a when in the closed position, the underside of the lid members 18 is also configured to form a seal with the side walls 16 when in the closed position. This is achieved by providing a groove or channel 29 along the lateral edges of the underside of the lid members 18 that receives a longitudinal ridge 27 provided along the upper end of the side walls, as is shown in FIG. 10. In such an arrangement, the lid members 18 inter-engage with the side walls 16 when closed to provide a fully insulated container 10.

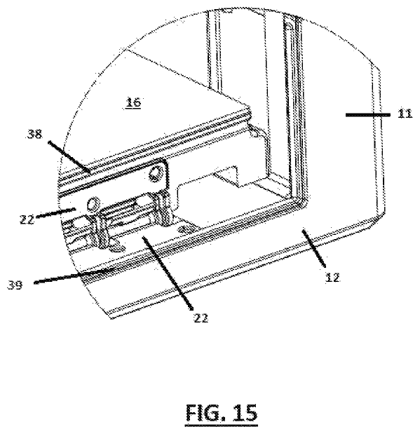

The container 10 of the present invention is configured such that, as the components of the container are assembled, the interfaces between the surfaces adjacent the hinges form a seal to maximise the thermal efficiency of the internal space of the container 10. This is depicted in FIG. 15, wherein the underside of the side walls 16 are provided with a rib 38 that extends the length thereof. A corresponding channel 39 is formed in the surface of the base 12 such that as the side wall is erected into the assembled position, the rib 38 is received within the channel 39 thereby forming a seal between the side wall 16 and the base that extends along the length thereof. The rib 38 is configured to be slightly larger than the corresponding channel 39 so as to create an interference fit that facilitates sealing along this intersection due to the elastic properties of the expanded material that the components are formed from. Such a seal is created along all common edges of the container 10, where components fold and intersect to improve the thermal properties of the container 10.

It will be appreciated that the container 10 as described above comprises a plurality of components that can be each formed separately and assembled together by way of snap fit hinges to form a fully insulated and interlocked container. This is depicted in FIG. 6 where the various components of the container 10 are shown prior to assembly. By forming the container in such a manner, all side walls, end walls and lid members are designed in such a way that during formation a mould can be formed whereby room is reserved for foam injectors, allowing for the panels to be moulded in a substantial vertical alignment with opening mould vector. This approach allows the mould foot print to be optimized and make better use of the machine area available to form the tooling.

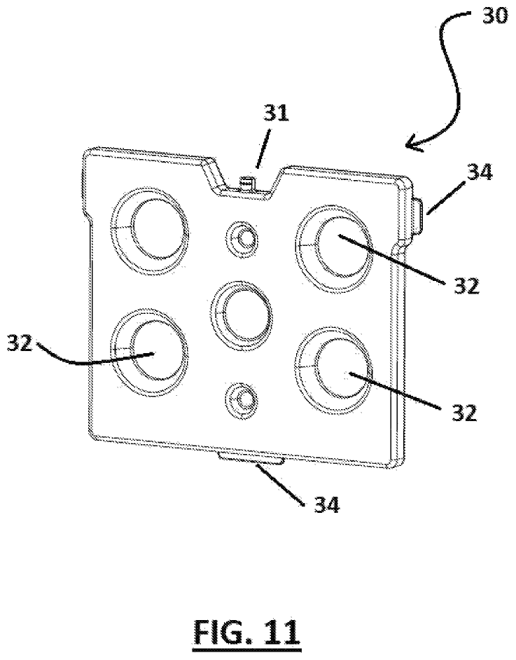

To further improve the thermal capacity of the container 10, temperature control packs 30 may be provided, as shown in FIG. 11. The temperature control packs 30 may comprise a substantially rectangular body that is hollow and capable of being filled with a liquid to emit either a cold or hot temperature into the container, depending on the type of fluid used. The packs 30 may have a small thickness and resemble a thin panel, and optionally, may have a plurality of holes or recesses 32 formed therethrough. The holes or recesses 32 may provide a means for handling the packs 30 and maximise the carriage space of the container 10. A spout 31 is provided in the pack 30 to provide a means for filling the pack 30 with the working fluid and the pack 30 can then be placed in a freezer or the like, as required.

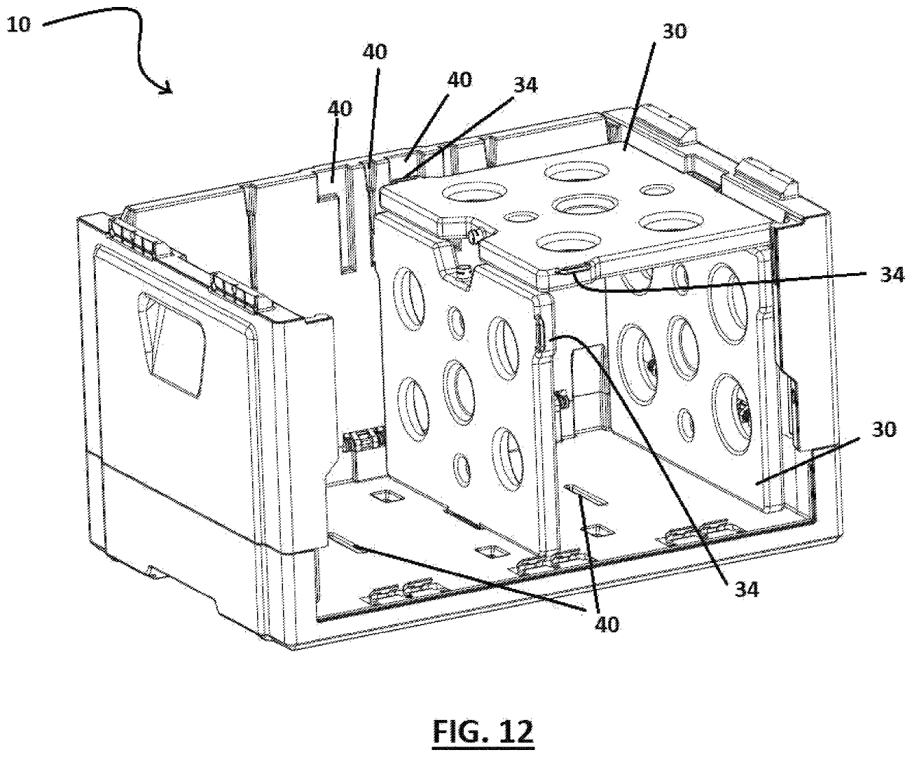

As is depicted, the edges of the pack 30 have wings 34 shaped to project therefrom. The wings 34 are configured to be received in channels or grooves 40 formed on the inner surface of the side walls 16, end walls 14 and base 12 as is shown in FIG. 12. The width and height of the packs 30 is substantially equal to the internal width of the container 10 such that when the packs are employed in a vertical or horizontal manner, they span the breadth of the container to form vertical or horizontal dividers.

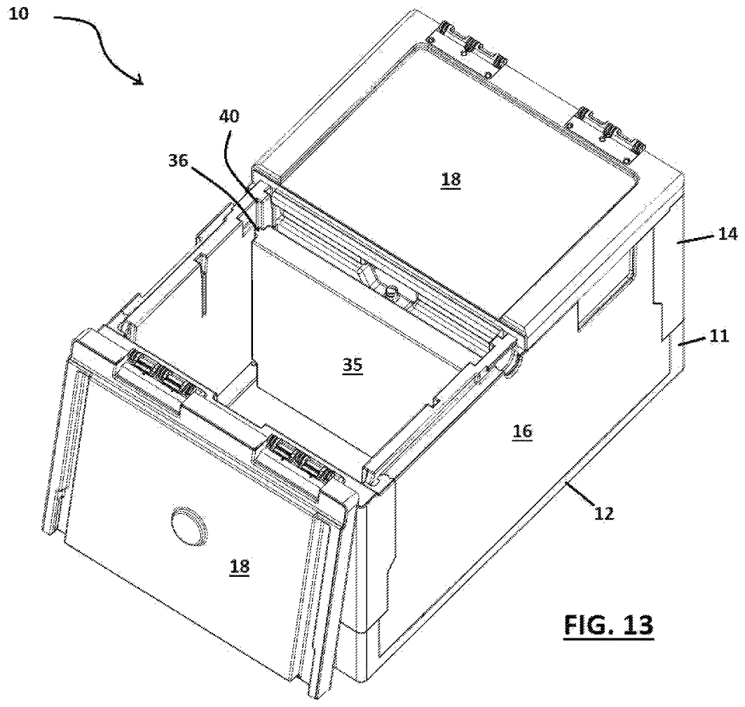

As is shown in FIG. 13, the container 10 may be compartmentalised through the provision of a divider 35 that is configured to span the internal space of the container 10 at a central location thereof. The divider 35 is preferably made from an expandable material, such as EPP, and is shaped to have ends 36 that are received within the grooves 40 formed in the side walls 16 to form two thermally isolated compartments within the container 10, each of which can be separately accessed by one of the lid members 18. In such an arrangement, one or more dividers 35 can be used to divide the container into a two or more compartments that can be used to store items in different thermal environments, such as a heated environment and a chilled environment. In such an arrangement, due to the insulated nature of the container the compartments can be thermally isolated from each other.

Referring to FIG. 12, the packs 30 can be arranged in a vertical and horizontal manner as required to provide multiple different assembled temperature zones within the container for different goods, such as frozen, chilled, ambient or hot. The packs 30 may be dedicated for use as a vertical or horizontal divider, or the packs 30 may be configured for use as both a horizontal or vertical divider. As the wings 34 are securely received within the slots 40, the packs 30 will be securely held during transport of the container. It will be appreciated that the packs 30 provide a unique system that allows the container to be used with the packs 30 in a series of different layouts to tailor thermal performance according to the goods being contained by the container.

To carry the container 10 in a manner that does not place undue forces at the hinges, handle recesses 45 are provided in the base 12 at the ends of the container 10, as shown in FIG. 2. The handle recesses 45 provide a recess for a user to grip the container at either ends of the base 12, and as the base 12 is a single piece, there is no transferral of forces into the walls of the container 10, which may place undue forces upon the hinges of the container. This allows the container 10, which may be laden with items of considerable weight, to be transported in a manner that ensures structural integrity of the container is maintained.

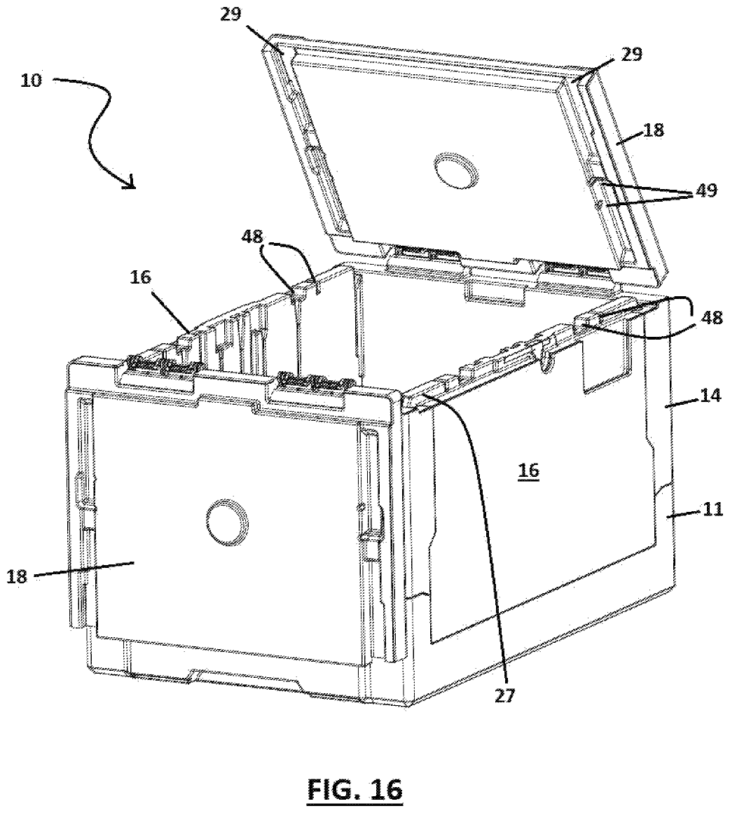

The container 10 of the present invention is configured to support bags (not shown) for containing items within the container. To achieve this, as depicted in FIG. 16, the side panels 16 have slots 48 formed within the ridge 27 located along the upper end of the side panels 16. The slots 48 are configured to receive the bags (not shown) and retain the bags in an open position within the container 10. Similar slots 49 are also formed in the channel 29 of the lid members 18 to avoid interference with the bags (not shown) and to retain the bags (not shown) in position when the lid 18 is in a closed and sealed position.

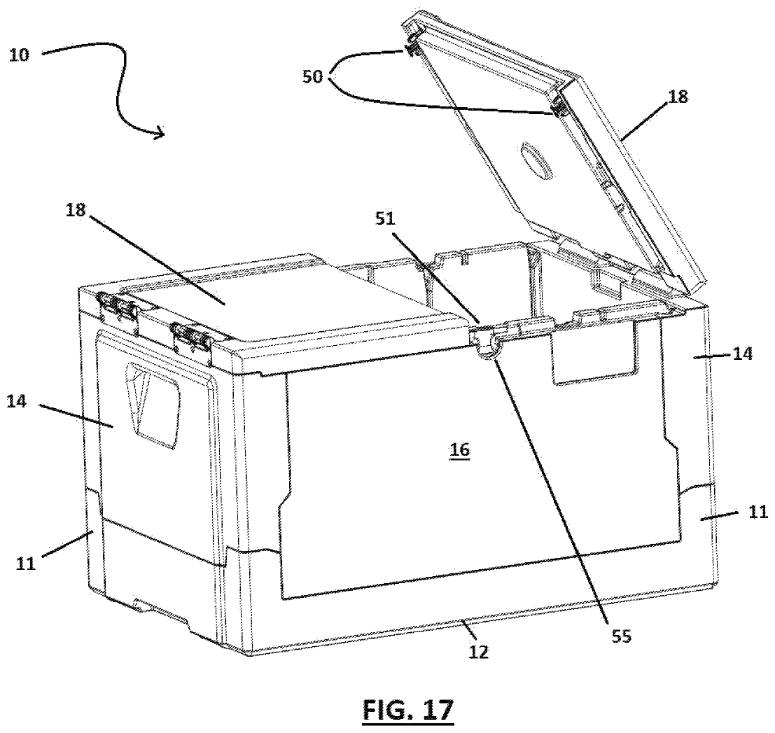

To lock the lid members 18 in position a locking mechanism may be employed. The locking mechanism comprises a male locking member 50 that is configured to be fitted into a recess formed in an undersurface of the lid member 18 so as to project from an underside thereof in the manner as depicted in FIG. 17. A female locking member 51 is inserted into a slot formed in an upper end of the side wall 16 to receive the male locking member 50 and engage therewith to secure the lid member 18 in position. As the lid members 18 inter-engage at their free ends when in the closed position, only one lid member 18 is required to be locked in position to secure the lid in place. An access recess 55 is formed in the outer surface of the side wall 16 at a top end thereof to open the lid members 18 when in the closed position.

The female locking member 51 is located immediately above the access recess 55 such that a user can simply use their finger to disengage the male locking member 50 from the female locking member 51 and open the container 10. In a preferred embodiment, the female locking member 51 is embossed inside the side wall 16 and therefore protected against accidental unlock by physical contact with the female locking member 51.

As is shown in FIG. 1, the outer surface of the end wall 14 has a recessed perimeter 56 that defines a central portion 57 that projects from the end wall 14 further than the surface of the recessed perimeter 56. In contrast, the outer surface of the lid member 18 has a central portion 59 that is recessed below the perimeter 58. In this regard, when the lid member 18 is opened in the manner as depicted in FIG. 16, the central portion 57 of the outer surface of the end wall 14 nests within the central portion 59 of the lid member 18. This nesting arrangement aids in protecting the hinges 24 connecting the end wall 14 and the lid member 18 by taking up any load that may be incident in the hinge when the lid is in the open position, thereby enhancing the longevity of the container and the hinges.

The container 10 is configured to support labels to assist in identifying the container 10 as well as the contents provided within the container 10. As is shown in FIG. 1, the side walls 16 of the container 10 has a recess 60 formed along a top edge thereof. The recess 60 defines a thin slot into which a label can be inserted without the use of adhesives or the like. The label is simply held in place by closing the lid member 18, which closes the opening to the recess 60 and secures the label in position. This enables the container to be used to contain a variety of different products as required.

It will be appreciated that the container of the present invention provides a simple and effective container for use in handling goods in an insulated environment. The container comprises multiple components that can be separately formed and assembled together to provide a sealed environment into which items can be stored. The components can be folded into a collapsed state for storage and can be simply assembled from the folded state to reform the insulated container.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the container uppermost.

It will be appreciated by those skilled in the art that many modifications and variations may be made to the methods of the invention described herein without departing from the spirit and scope of the invention.

1. A container for storing items in an insulated environment, comprising:
a base having integrally formed opposing end supports projecting above a surface of the base and at least one elevated edge extending between the opposing end supports;
a pair of end walls, each end wall hingedly mounted to an upper end of the end supports;
a pair of side walls, one of the side walls being hingedly mounted to a surface of the base along an edge thereof to extend between the end supports and the other side wall being hingedly mounted to an upper end of the elevated edge of the base to extend between the end supports; and
a pair of lid members, each lid member being hingedly mounted to an upper end of the end walls or side walls;
wherein, in a first folded state each of the side walls, end walls and lid members are foldable to extend over the base in a stacked manner, and in a second assembled state each of the side walls, end walls and lid members are interengage to form a sealed and insulated storage space.

2. A container according to claim 1, wherein the upper end of the elevated edge of the base is elevated above the surface of the base a height equivalent to a thickness of the side wall mounted to the surface of the base.

3. A container according to claim 2, wherein when the side walls are folded inwardly in the first folded state, the side wall mounted to the surface of the base is positioned below the side wall mounted to the elevated edge of the base.

4. A container according to claim 3, wherein when the side walls are folded inwardly in the first folded state the combined height of the side walls above the surface of the base is substantially the same as the height of the end supports above the surface of the base.

5. A container according to claim 4, wherein when the end walls are folded inwardly in the first folded state, the end walls are supported on an upper surface of the folded side walls.

6. A container according to claim 1, wherein the pair of side walls are mounted to the surface of the base and the upper end of the elevated edge of the base by way of one or more hinge members.

7. A container according to claim 6 wherein the hinge members are configured to facilitate pivotal movement of the side walls between the first folded state and the second assembled state and to prevent pivotal movement of the side walls outside of these states.

8. A container according to claim 1, wherein the pair of end walls are mounted to the upper end of the end supports by way of one or more hinge members.

9. A container according to claim 8, wherein the hinge members are configured to facilitate pivotal movement of the end walls between the first folded state and the second assembled state and to prevent pivotal movement of the end walls outside of these states.

10. A container according to claim 1, wherein each of the end walls have side members that project from opposing sides of the end walls to engage with the side walls when the end walls and side walls are in the second assembled state.

11. A container according to claim 10, wherein the side members project in a direction toward the other end wall when the end walls 14 are in the second assembled state.

12. A container according to claim 11, wherein side members of the end walls engage with the side walls to form a sealed edge therebetween.

13. A container according to claim 12, wherein a groove is formed along an inner surface of the side members that receives a tongue member formed on an outer surface of the side wall to form the sealed edge therebetween.

14. A container according to claim 1 wherein an interface between the base and the side walls and the base and the end walls are configured to form a seal therebetween when the side walls and the end walls are in the second assembled state.

15. A container according to claim 14, wherein the seal is formed by a rib provided in either the end wall/side wall or base being received in a channel provided in either the base or end wall/side wall when the side walls and end walls are in the second assembled state.

16. A container according to claim 15, wherein the rib is configured to be slightly larger than the channel such that when the rib is brought into contact with the channel an interference fit is created to form a seal along the interface.

17. A container in accordance with claim 1, wherein the base, side walls, end walls and lid members are detachable.
